(19) United States
(12) Patent Application Publication
(10) Pub. No.: US 2022/0389925 A1
(43) Pub. Date: Dec. 8, 2022

(54) ROTARY PUMP

(71) Applicants: Sumitomo Electric Sintered Alloy, Ltd., Takahashi-shi, Okayama (JP); Sumitomo Electric Industries, Ltd., Osaka-shi, Osaka (JP)

(72) Inventors: Shoichi TAKADA, Takahashi-shi, Okayama (JP); Masato UOZUMI, Takahashi-shi, Okayama (JP); Makoto NAKABAYASHI, Osaka-shi, Osaka (JP); Eiichi KOBAYASHI, Osaka-shi, Osaka (JP); Kazuaki IKEDA, Osaka-shi, Osaka (JP)

(73) Assignees: Sumitomo Electric Sintered Alloy, Ltd., Takahashi-shi, Okayama (JP); Sumitomo Electric Industries, Ltd., Osaka-shi, Osaka (JP)

(21) Appl. No.: 17/775,343

(22) PCT Filed: Dec. 24, 2019
(86) PCT No.: PCT/JP2019/050613

§ 371 Date: May 9, 2022

(51) Int. Cl. F04C 2/10; F04C 18/10

(52) U.S. Cl. CPC F04C 2/103; F04C 18/10

(57) ABSTRACT

Provided is a rotary pump including: a pump rotor having a flat first rotor side surface facing one side in an axial direction, and a flat second rotor side surface facing the other side in the axial direction; and a housing configured to rotatably house the pump rotor. The housing includes: a ring member having a hollow tubular shape and openings at both ends in the axial direction; a first side member detachably mounted to one end in the axial direction of the ring member to slide and guide the first rotor side surface by using a first crosslinked fluororesin flat surface formed of a crosslinked fluororesin; and a second side member detachably mounted to the other end in the axial direction of the ring member to slide and guide the second rotor side surface by using a second crosslinked fluororesin flat surface formed of the crosslinked fluororesin.

### TECHNICAL FIELD

The present disclosure relates to a rotary pump.

### BACKGROUND ART

A rotary pump described in PATENT LITERATURE 1 has been known as a rotary pump that performs suction and discharge of fluid by rotating a pump rotor. The rotary pump described in PATENT LITERATURE 1 includes a pump rotor, and a housing that rotatably houses the pump rotor.

Generally, a clearance for allowing rotation of the pump rotor is set between sliding surfaces of the housing and the pump rotor. If this clearance is large, a leakage amount of fluid increases and a discharge amount of a pump decreases. Therefore, the clearance between the sliding surfaces of the housing and the pump rotor is preferably small. However, if the clearance is too small, seizure is likely to occur between the housing and the pump rotor. Therefore, the clearance between the sliding surfaces of the housing and the pump rotor is usually set to several tens of micrometers or more.

The inventors of the present application have developed a rotary pump in which a clearance between sliding surfaces of a housing and a pump rotor can be set to be extremely small while avoiding seizure between the housing and the pump rotor, and proposed a rotary pump disclosed in PATENT LITERATURE 2.

The rotary pump disclosed in PATENT LITERATURE 2 includes a pump rotor, and a housing that rotatably houses the pump rotor. One or both of the housing and the pump rotor are coated with crosslinked fluororesin. Since crosslinked fluororesin has a low coefficient of friction and a high wear resistance, if one or both of the housing and the pump rotor are coated with crosslinked fluororesin, seizure between the housing and the pump rotor can be avoided over a long period of time even when the clearance between the sliding surfaces of the housing and the pump rotor is set to be extremely small.

### CITATION LIST

### Patent Literature

PATENT LITERATURE 1: Japanese Laid-Open Patent Publication No. 2014-47751

PATENT LITERATURE 2: Japanese Laid-Open Patent Publication No. 2014-173513

### SUMMARY OF THE INVENTION

### Solution to Problem

A rotary pump according to one aspect of the present disclosure is a rotary pump including:

a pump rotor having a flat first rotor side surface facing one side in an axial direction, and a flat second rotor side surface facing the other side in the axial direction; and

a housing configured to rotatably house the pump rotor, wherein

the housing includes

a ring member having a hollow tubular shape and openings at both ends in the axial direction, the ring member surrounding an outer side in a radial direction of the pump rotor,

a first side member detachably mounted to one end in the axial direction of the ring member, the first side member configured to slide and guide the first rotor side surface by using a first crosslinked fluororesin flat surface formed of a crosslinked fluororesin, and

a second side member detachably mounted to the other end in the axial direction of the ring member, the second side member configured to slide and guide the second rotor side surface by using a second crosslinked fluororesin flat surface formed of the crosslinked fluororesin.

### BRIEF DESCRIPTION OF DRAWINGS

FIG. 1 is an exploded perspective view of a rotary pump according to a first embodiment of the present disclosure.

FIG. 2 is a front view of the rotary pump shown in FIG. 1.

FIG. 3 is a cross-sectional view taken along a III-III line in FIG. 2.

FIG. 4 is a cross-sectional view take along a IV-IV line in FIG. 3.

FIG. 5 is an enlarged view around the pump rotor shown in FIG. 3.

FIG. 6 is a cross-sectional view taken along a VI-VI line in FIG. 2.

FIG. 7 is an exploded perspective view of a rotary pump according to a second embodiment of the present disclosure.

FIG. 8 is an enlarged cross-sectional view showing the rotary pump of FIG. 7 corresponding to FIG. 5.

FIG. 9 is an exploded perspective view showing a rotary pump according to a third embodiment of the present disclosure.

FIG. 10 shows a rotary pump, corresponding to FIG. 4, according to a fourth embodiment of the present disclosure.

FIG. 11 is a cross-sectional view taken along an XI-XI line in FIG. 10.

FIG. 12 is an enlarged view around the pump rotor shown in FIG. 11.

### DETAILED DESCRIPTION

### Problems to be Solved by the Present Disclosure

The inventors of the present application have advanced in-house development of the rotary pump in which at least one of the housing and the pump rotor is coated with crosslinked fluororesin as described in PATENT LITERATURE 2, and considered mass production of a rotary pump in which an inner surface of a housing is coated with crosslinked fluororesin.

The housing is composed of a housing body, and a cover detachably mounted to the housing body. The housing body is a member in which a first side part that slides and guides one side surface in an axial direction of a pump rotor, and a ring-like part surrounding an outer side in a radial direction of the pump rotor, are formed into one body without a joint. The cover is a second side part that slides and guides the other side surface in the axial direction of the pump rotor. The inventors have considered mass production of a rotary pump in which a housing body and a cover are coated with crosslinked fluororesin.

However, the inventors have found that actual mass production of the rotary pump in which the inner surface of the housing is coated with crosslinked fluororesin has drawbacks as follows.

That is, when the side part (the part that slides and guides one side surface in the axial direction of the pump rotor) of the housing body is coated with crosslinked fluororesin, the surface of the crosslinked fluororesin needs strict dimensional control because the surface is a part that determines the size of a clearance between the sliding surfaces of the housing and the pump rotor. Meanwhile, when the side part of the housing body is coated with crosslinked fluororesin, it is difficult to coat the side part with a uniform thickness because of presence of the ring-like part (the part surrounding the outer side in the radial direction of the pump rotor) rising from the side part. Moreover, after coating of the side part of the housing body with the crosslinked fluororesin, if grinding of the surface of the crosslinked fluororesin is required, internal grinding should be performed to avoid interference with the ring-like part rising from the side part, which results in high machining cost and poor mass productivity.

Therefore, an object of the present disclosure is to provide a rotary pump which can accurately control a clearance between a housing whose sliding surface with respect to a side surface in the axial direction of a pump rotor is formed of crosslinked fluororesin, and a side surface in the axial direction of the pump rotor, and which is excellent in mass productivity.

### Effects of the Present Disclosure

According to the present disclosure, it is possible to provide a rotary pump which can accurately control a clearance between a housing whose sliding surface with respect to a side surface in the axial direction of a pump rotor is formed of crosslinked fluororesin, and a side surface in the axial direction of the pump rotor, and which is excellent in mass productivity.

### Description of Embodiment of the Present Disclosure

(1) A rotary pump according to one aspect of the present disclosure is a rotary pump including:

a pump rotor having a flat first rotor side surface facing one side in an axial direction, and a flat second rotor side surface facing the other side in the axial direction; and

a housing configured to rotatably house the pump rotor, wherein

the housing includes

a ring member having a hollow tubular shape and openings at both ends in the axial direction, the ring member surrounding an outer side in a radial direction of the pump rotor,

a first side member detachably mounted to one end in the axial direction of the ring member, the first side member configured to slide and guide the first rotor side surface by using a first crosslinked fluororesin flat surface formed of a crosslinked fluororesin, and

a second side member detachably mounted to the other end in the axial direction of the ring member, the second side member configured to slide and guide the second rotor side surface by using a second crosslinked fluororesin flat surface formed of the crosslinked fluororesin.

In the above configuration, since the first side member and the second side member are detachable from the ring member surrounding the radially outer side of the pump rotor, the first crosslinked fluororesin flat surface and the second crosslinked fluororesin flat surface can be accurately formed in the state where the ring member is absent. Therefore, clearances between the first crosslinked fluororesin flat surface and the second crosslinked fluororesin flat surface, and the side surfaces in the axial direction of the pump rotor can be accurately controlled, and moreover, excellent mass productivity can be achieved.

(2) Preferably, the ring member includes a first flange surface formed around one opening in the axial direction of the ring member, and a second flange surface formed around the other opening in the axial direction of the ring member,

the first side member has a first mating surface fixed while being in contact with the first flange surface, and the first mating surface is formed of the crosslinked fluororesin contiguous with the crosslinked fluororesin forming the first crosslinked fluororesin flat surface, and

the second side member has a second mating surface fixed while being in contact with the second flange surface, and the second mating surface is formed of the crosslinked fluororesin contiguous with the crosslinked fluororesin forming the second crosslinked fluororesin flat surface.

In the above configuration, since both the first mating surface, of the first side member, facing the ring member, and the second mating surface, of the second side member, facing the ring member are formed of the crosslinked fluororesin, the crosslinked fluororesin realizes sealing between the contact surfaces of the first side member and the ring member, and sealing between the contact surfaces of the second side member and the ring member. Moreover, the crosslinked fluororesin forming the first mating surface is contiguous with the crosslinked fluororesin forming the first crosslinked fluororesin flat surface that slides and guides the pump rotor, and the crosslinked fluororesin forming the second mating surface is contiguous with the crosslinked fluororesin forming the second crosslinked fluororesin flat surface that slides and guides the pump rotor, which results in reduction in production cost.

(3) In a case where the first side member or the second side member has: a suction port opened at a surface opposing the first rotor side surface or a surface opposing the second rotor side surface; a discharge port opened at a distance in a circumferential direction from the suction port; and a non-opening portion separating the suction port and the discharge port in the circumferential direction,

the first crosslinked fluororesin flat surface or the second crosslinked fluororesin flat surface is preferably formed on the non-opening portion.

In the above configuration, since a clearance between the pump rotor and the non-opening portion separating the suction port and the discharge port can be set to be extremely small, the leakage amount of fluid from the discharge port to the suction port can be effectively reduced, whereby the discharge amount of the pump can be effectively improved.

(4) In a case where a rotation shaft for rotating the pump rotor is disposed so as to have a portion protruding in the axial direction from the pump rotor,

the first side member or the second side member preferably includes: a side block to which a bearing is mounted, the bearing rotatably supporting the portion, of the rotation shaft, protruding in the axial direction from the pump rotor; and a sliding plate that is fixed by being sandwiched between the side block and the ring member, and has the first crosslinked fluororesin flat surface or the second crosslinked fluororesin flat surface.

In the above configuration, since the first crosslinked fluororesin flat surface or the second crosslinked fluororesin flat surface is formed not on the side block to which the bearing is mounted, but on the sliding plate which is a member separate from the side block, formation of the crosslinked fluororesin flat surface is facilitated.

(5) The sliding plate may be composed of a metal plate, and a crosslinked fluororesin coating formed on at least a surface, of the metal plate, on a side where the ring member is present.

In the above configuration, since strength of the sliding plate can be ensured, breakage of the sliding plate can be avoided when the sliding plate is sandwiched between the side block and the ring member.

(6) The crosslinked fluororesin coating may be formed on both a surface, of the metal plate, on a side where the side block is present, and the surface, of the metal plate, on the side where the ring member is present.

In the above configuration, since dipping or the like can be used as a coating method, the crosslinked fluororesin coating having an accurate thickness can be inexpensively obtained.

(7) The sliding plate may be a plate formed of the crosslinked fluororesin.

(8) The pump rotor may be composed of: an inner rotor having, at an outer periphery thereof, a plurality of outer teeth; and an annular outer rotor supported to be rotatable around a position eccentric from a center of the inner rotor, the outer rotor having, at an inner periphery thereof, a plurality of inner teeth meshing with the outer teeth.

(9) The pump rotor may be composed of: a rotor body having, at an outer periphery thereof, a plurality of vane-containing grooves; and a plurality of vanes contained in the respective vane-containing grooves so as to be slidable in the radial direction.

### Details of Embodiment of the Present Disclosure

Hereinafter, specific examples of rotary pumps according to embodiments of the present disclosure will be described with reference to the drawings. The present invention is not limited to these examples and is indicated by the claims, and is intended to include meaning equivalent to the claims and all modifications within the scope of the claims.

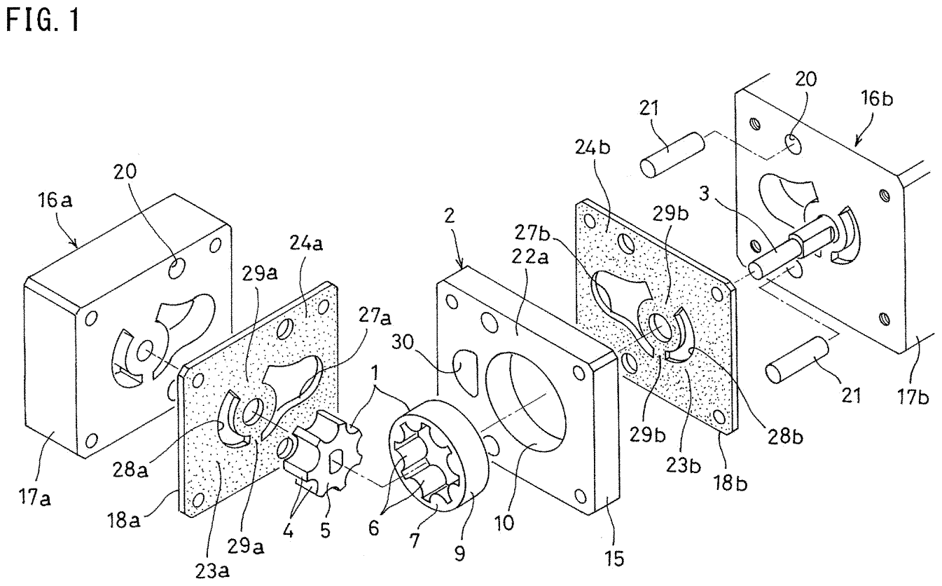

FIG. 1 to FIG. 6 show a rotary pump according to a first embodiment of the present disclosure. The rotary pump includes a pump rotor 1, a housing 2 that rotatably houses the pump rotor 1, and a rotation shaft 3 that rotates the pump rotor 1.

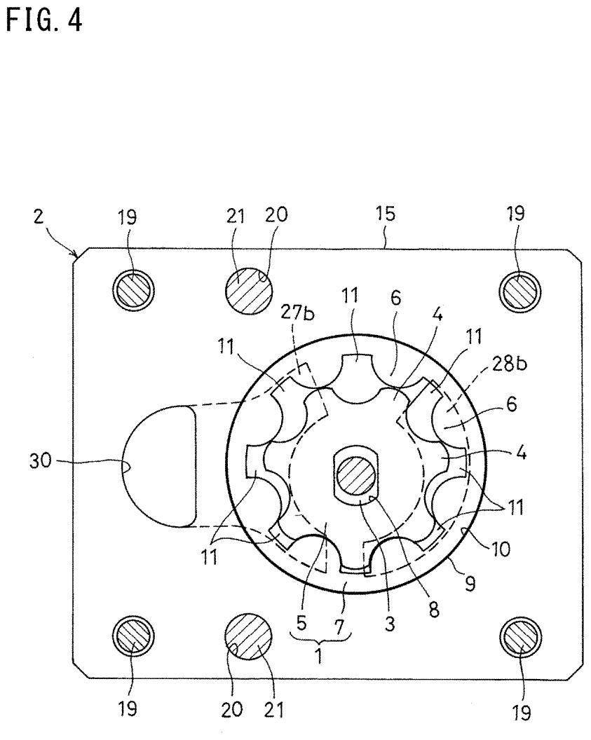

As shown in FIG. 1 and FIG. 4, the pump rotor 1 is composed of: an inner rotor 5 having, at an outer periphery thereof, a plurality of outer teeth 4; and an annular outer rotor 7 having, at an inner periphery thereof, a plurality of inner teeth 6 that mesh with the outer teeth 4.

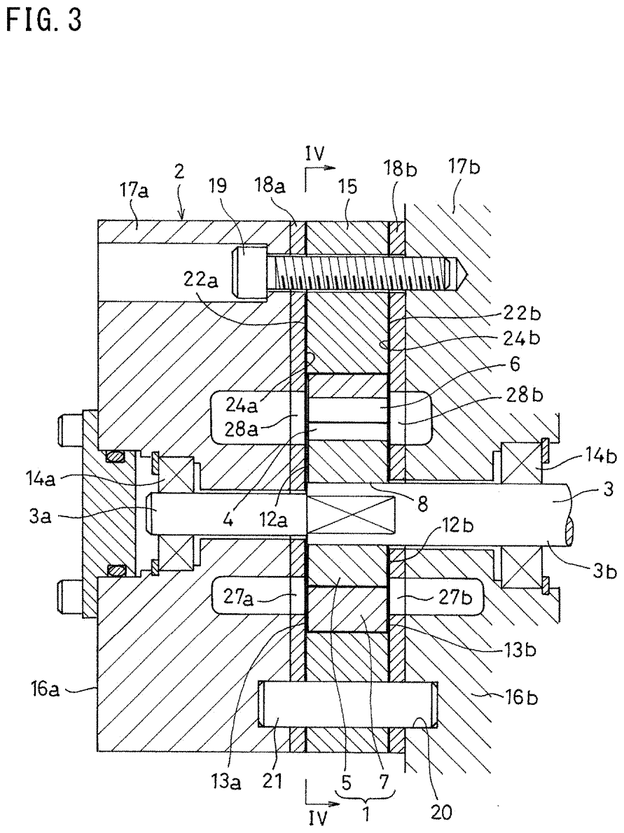

As shown in FIG. 3, the inner rotor 5 has an axial hole 8 through which the rotation shaft 3 is inserted. The rotation shaft 3 and the axial hole 8 are fitted to each other such that the rotation shaft 3 and the inner rotor 5 integrally rotate. Fitting of the rotation shaft 3 and the axial hole 8 is not limited to width-across-flat fitting shown in FIG. 3. Spline fitting, key groove fitting, or a fitting with an interference between cylindrical surfaces (shrinkage fitting or press fitting) may be adopted.

As shown in FIG. 4, the outer rotor 7 has an outer peripheral cylindrical surface 9. The outer peripheral cylindrical surface 9 is fitted to an inner peripheral cylindrical surface 10 of the housing 2 with a gap therebetween, and this fitting rotatably supports the outer rotor 7. The outer rotor 7 is supported to be rotatable around a position eccentric from a center position of the inner rotor 5 (i.e., a rotation center position of the rotation shaft 3). When the inner rotor 5 is rotated, the outer rotor 7 rotates together with the inner rotor 5 due to meshing of the inner teeth 6 with the outer teeth 4. The rotation direction of the inner rotor 5 is the clockwise direction in FIG. 4.

The number of the inner teeth 6 of the outer rotor 7 is larger by one than the number of the outer teeth 4 of the inner rotor 5. A plurality of chambers 11 (spaces for containing fluid) demarcated by the respective outer teeth 4 and the respective inner teeth 6 are formed between the outer periphery of the inner rotor 5 and the inner periphery of the outer rotor 7. The plurality of chambers 11 are configured such that the volume of each chamber 11 changes with rotation of the inner rotor 5 and the outer rotor 7. That is, the volume of each chamber 11 is maximum at an angular position (upper position in FIG. 4) at which the center of the inner rotor 5 and the center of the outer rotor 7 are most distant from each other, and gradually decreases as the chamber 11 approaches an angular position (lower position in FIG. 4) at which the center of the inner rotor 5 and the center of the outer rotor 7 are closest to each other. Therefore, when the inner rotor 5 and the outer rotor 7 rotate, on a side (right side in FIG. 4) where the chamber 11 moves from the angular position at which the center of the inner rotor 5 and the center of the outer rotor 7 are most distant from each other, toward the angular position at which the center of the inner rotor 5 and the center of the outer rotor 7 are closest to each other, the volume of the chamber 11 is reduced and thereby a fluid discharge effect occurs. Meanwhile, on a side (left side in FIG. 4) where the chamber 11 moves from the angular position at which the center of the inner rotor 5 and the center of the outer rotor 7 are closest to each other, toward the angular position at which the center of the inner rotor 5 and the center of the outer rotor 7 are most distant from each other, the volume of the chamber 11 gradually increases and thereby a fluid suction effect occurs.

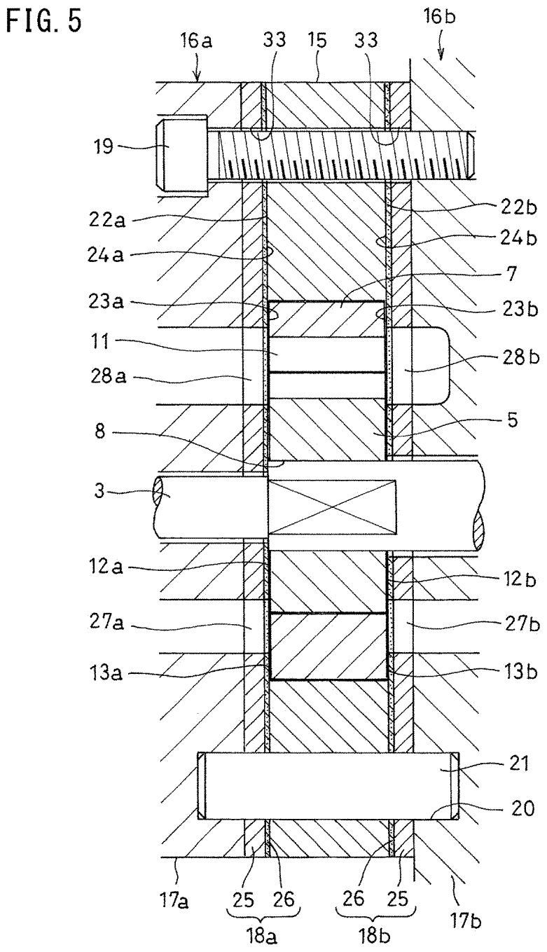

As shown in FIG. 5, the inner rotor 5 has a flat first inner rotor side surface 12a facing one side (left side in FIG. 5) in the axial direction, and a flat second inner rotor side surface 12b facing the other side (right side in FIG. 5) in the axial direction. The first inner rotor side surface 12a and the second inner rotor side surface 12b are parallel flat surfaces facing opposite to each other in the axial direction. The outer rotor 7 has a flat first outer rotor side surface 13a facing one side in the axial direction, and a flat second outer rotor side surface 13b facing the other side in the axial direction. The first outer rotor side surface 13a and the second outer rotor side surface 13b are parallel flat surfaces facing opposite to each other in the axial direction.

A width in the axial direction of the inner rotor 5 from the first inner rotor side surface 12a to the second inner rotor side surface 12b is equal to a width in the axial direction of the outer rotor 7 from the first outer rotor side surface 13a to the second outer rotor side surface 13b. The first inner rotor side surface 12a and the first outer rotor side surface 13a are flush with each other, and the second inner rotor side surface 12b and the second outer rotor side surface 13b are also flush with each other. Both the inner rotor 5 and the outer rotor 7 are formed of a sintered parts. The sintered parts is a member obtained by compression-molding an iron-base powder material by using a mold to form a powder molded body, and heating the powder molded body at a high temperature equal to or lower than a melting point.

As shown in FIG. 3, the axial hole 8 in which the rotation shaft 3 is inserted is a through-hole penetrating through the inner rotor 5 in the axial direction. The rotation shaft 3 is inserted in the axial hole 8 so as to have a portion 3a protruding from the inner rotor 5 to one side (left side in FIG. 3) in the axial direction, and a portion 3b protruding from the inner rotor 5 to the other side (right side in FIG. 3) in the axial direction. The portion 3a, of the rotation shaft 3, protruding to one side in the axial direction of the inner rotor 5 is rotatably supported by a first bearing 14a, and the portion 3b, of the rotation shaft 3, protruding to the other side in the axial direction from the inner rotor 5 is rotatably supported by a second bearing 14b. The portion 3b, of the rotation shaft 3, protruding to the other side in the axial direction from the inner rotor 5 is connected to a rotation driving device (electric motor or the like) which is not shown.

The housing 2 includes: a ring member 15 formed in a hollow tubular shape surrounding a radially outer side of the pump rotor 1 (the inner rotor 5 and the outer rotor 7); a first side member 16a detachably mounted to one end (left end in FIG. 3) in the axial direction of the ring member 15; and a second side member 16b detachably mounted to the other end (right end in FIG. 3) in the axial direction of the ring member 15.

The first side member 16a is composed of: a first side block 17a to which the first bearing 14a is mounted; and a first sliding plate 18a sandwiched between the first side block 17a and the ring member 15. Likewise, the second side member 16b is composed of: a second side block 17b to which the second bearing 14b is mounted; and a second sliding plate 18b sandwiched between the second side block 17b and the ring member 15.

The first side block 17a, the first sliding plate 18a, the ring member 15, the second sliding plate 18b, and the second side block 17b are fixed to each other by being fastened in the axial direction with a common bolt 19. Moreover, the first side block 17a, the first sliding plate 18a, the ring member 15, the second sliding plate 18b, and the second side block 17b are positioned in a direction perpendicular to the axial direction by a common knock pin 21 being inserted through knock-pin insertion holes 20 formed in the respective components.

As shown in FIG. 5, the ring member 15 is formed in a hollow tubular shape having openings at both ends in the axial direction. The ring member 15 has: a first flange surface 22a formed around the opening on one side (left side in FIG. 5) in the axial direction of the ring member 15; and a second flange surface 22b formed around the opening on the other side (right side in FIG. 5) in the axial direction of the ring member 15. The first flange surface 22a and the second flange surface 22b are parallel flat surfaces facing opposite to each other in the axial direction.

The first sliding plate 18a has: a first crosslinked fluororesin flat surface 23a that slides and guides the first inner rotor side surface 12a and the first outer rotor side surface 13a; and a first mating surface 24a that is fixed while being in contact with the first flange surface 22a. The first sliding plate 18a is composed of a metal plate 25, and a crosslinked fluororesin coating 26 formed on a surface, of the metal plate 25, on the ring member 15 side. In this embodiment, the first crosslinked fluororesin flat surface 23a and the first mating surface 24a form a surface of the crosslinked fluororesin coating 26. The first mating surface 24a is formed of a crosslinked fluororesin contiguous with the crosslinked fluororesin forming the first crosslinked fluororesin flat surface 23a. That is, the entirety of one side of the first sliding plate 18a is coated with the crosslinked fluororesin. The first sliding plate 18a is a flat plate having a uniform thickness not larger than 5 mm (preferably, not larger than 4 mm).

The crosslinked fluororesin is obtained by crosslinking molecules of chain polymers forming a fluororesin. The crosslinked fluororesin has extremely high wear resistance while having a coefficient of friction as low as that of general fluororesin (non-crosslinked fluororesin).

As a fluororesin to be crosslinked, polytetrafluoroethylene (PTFE), tetrafluoroethylene-hexafluoropropylene copolymer (FEP), tetrafluoroethylene-perfluoroalkyl vinyl ether copolymer (PFA), or the like can be adopted. It is preferable to adopt crosslinked PTFE as the crosslinked fluororesin. When the crosslinked PTFE is adopted, pump efficiency can be effectively improved because the crosslinked PTFE has a particularly low coefficient of friction among the above fluororesins and is excellent in wear resistance, and therefore, is hardly worn.

The crosslinked fluororesin coating 26 made of a crosslinked fluororesin can be formed as follows, for example. First, a dispersion liquid obtained by dispersing fine particles of a fluororesin (e.g., PTFE) in water is applied to the surface of the metal plate 25. Next, the applied dispersion liquid is dried to form a layer of the fine particles of the fluororesin on the surface of the metal plate 25. Subsequently, the metal plate 25 and the layer of the fine particles of the fluororesin are heated to a temperature equal to or higher than the melting point of the fluororesin to bake the fine particles of the fluororesin, whereby the fine particles of the fluororesin are fused to each other. Thereafter, radiation (e.g., electron beam) is applied under a predetermined high-temperature, oxygen-free atmosphere to cause covalent bonding between the chain polymers forming the fluororesin, thereby crosslinking the molecules of the chain polymers. The radiation applied at this time also causes chemical bonding between the metal plate 25 and the molecules of the chain polymers forming the fluororesin, and the chemical bonding causes the crosslinked fluororesin coating 26 to be adhered to the metal plate 25 with extremely high adhesion. Thereafter, the surface of the crosslinked fluororesin coating 26 is subjected to grinding.

Likewise, the second sliding plate 18b has: a second crosslinked fluororesin flat surface 23b that slides and guides the second inner rotor side surface 12b and the second outer rotor side surface 13b; and a second mating surface 24b that is fixed while being in contact with the second flange surface 22b. The second sliding plate 18b is composed of a metal plate 25, and a crosslinked fluororesin coating 26 formed on a surface, of the metal plate 25, on the ring member 15 side. The second crosslinked fluororesin flat surface 23b and the second mating surface 24b form a surface of the crosslinked fluororesin coating 26. The second mating surface 24b is formed of the crosslinked fluororesin contiguous with the crosslinked fluororesin of the second crosslinked fluororesin flat surface 23b.

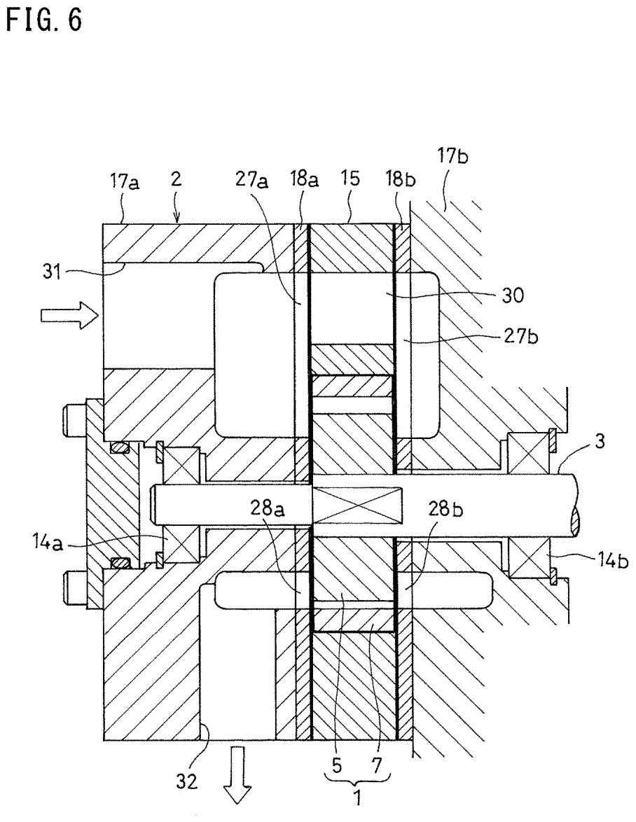

As shown in FIG. 6, the first sliding plate 18a is provided with: a first suction port 27a opened at a surface opposing the first inner rotor side surface 12a and the first outer rotor side surface 13a; a first discharge port 28a opened at a distance in the circumferential direction from the first suction port 27a; and a first non-opening portion 29a (see FIG. 1) that separates the first suction port 27a and the first discharge port 28a in the circumferential direction.

Likewise, the second sliding plate 18b is provided with: a second suction port 27b opened at a surface opposing the second inner rotor side surface 12b and the second outer rotor side surface 13b; a second discharge port 28b opened at a distance in the circumferential direction from the second suction port 27b; and a second non-opening portion 29b (see FIG. 1) that separates the second suction port 27b and the second discharge port 28b in the circumferential direction.

As shown in FIG. 1, each of the first suction port 27a and the first discharge port 28a is opened in an arc shape centered around the rotation shaft 3. On the first sliding plate 18a, the aforementioned first crosslinked fluororesin flat surface 23a is formed on the first non-opening portion 29a separating the first suction port 27a and the first discharge port 28a. Likewise, each of the second suction port 27b and the second discharge port 28b is opened in an arc shape centered around the rotation shaft 3. On the second sliding plate 18b, the aforementioned second crosslinked fluororesin flat surface 23b is formed on the second non-opening portion 29b separating the second suction port 27b and the second discharge port 28b.

The first suction port 27a and the second suction port 27b are opened so as to have the same shape at symmetrical positions with the inner rotor 5 and the outer rotor 7 sandwiched therebetween. Thus, a pressure that the first inner rotor side surface 12a and the first outer rotor side surface 13a receive from the fluid in the first suction port 27a is balanced with a pressure that the second inner rotor side surface 12b and the second outer rotor side surface 13b receive from the fluid in the second suction port 27b, thereby preventing the inner rotor 5 and the outer rotor 7 from being inclined.

Likewise, the first discharge port 28a and the second discharge port 28b are opened so as to have the same shape at symmetrical positions with the inner rotor 5 and the outer rotor 7 sandwiched therebetween. Thus, a pressure that the first inner rotor side surface 12a and the first outer rotor side surface 13a receive from the fluid in the first discharge port 28a is balanced with a pressure that the second inner rotor side surface 12b and the second outer rotor side surface 13b receive from the fluid in the second discharge port 28b, thereby preventing the inner rotor 5 and the outer rotor 7 from being inclined.

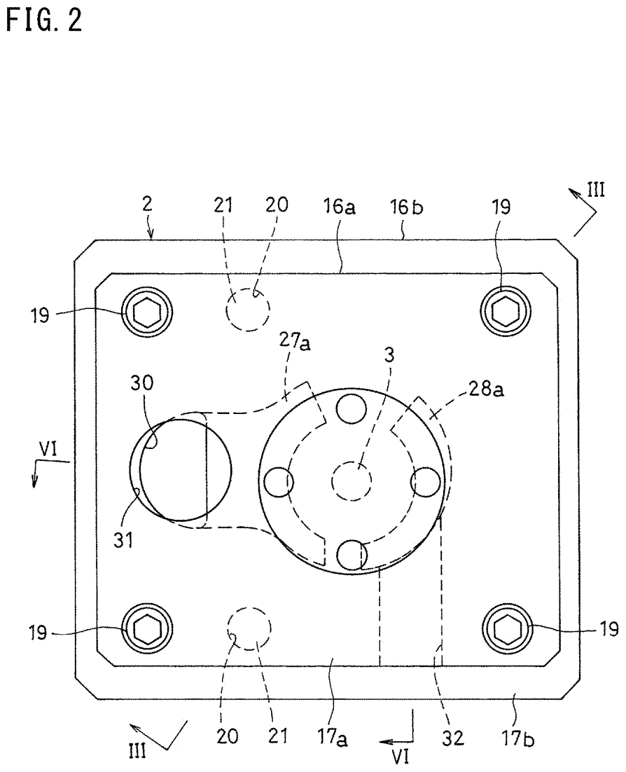

As shown in FIG. 4 and FIG. 6, the first suction port 27a and the second suction port 27b are in communication with each other via a communication path 30 formed at a position spaced apart from the opening, of the ring member 15, which houses the pump rotor 1. As shown in FIG. 2 and FIG. 6, the first suction port 27a is in communication with a suction port 31 opened at an outer surface of the first side block 17a, and the first discharge port 28a is in communication with a discharge port 32 opened at an outer surface of the first side block 17a.

As shown in FIG. 5, in the aforementioned rotary pump, the first crosslinked fluororesin flat surface 23a and the second crosslinked fluororesin flat surface 23b slide and guide the side surfaces in the axial direction of the inner rotor 5 and the outer rotor 7. Therefore, a clearance in the axial direction between the housing 2, and the inner rotor 5 and the outer rotor 7 (i.e., a difference between the inner width of the housing 2 and the width of the inner rotor 5 or the width of the outer rotor 7) can be set to an extremely small size (not larger than 20 μm, preferably, not larger than 15 μm, and more preferably, not larger than 10 μm).

Moreover, as shown in FIG. 1, in this rotary pump, since the first side member 16a and the second side member 16b are detachable from the ring member 15 surrounding the radially outer side of the pump rotor 1, the first crosslinked fluororesin flat surface 23a and the second crosslinked fluororesin flat surface 23b can be accurately formed in the state where the ring member 15 is absent. Therefore, clearances between the first crosslinked fluororesin flat surface 23a and the second crosslinked fluororesin flat surface 23b, and the side surfaces in the axial direction of the inner rotor 5 and the outer rotor 7 can be accurately controlled, and moreover, excellent mass productivity can be achieved.

In particular, in this rotary pump, the first crosslinked fluororesin flat surface 23a is formed not on the first side block 17a to which the first bearing 14a is mounted, but on the first sliding plate 18a which is a member separate from the first side block 17a. Therefore, formation of the first crosslinked fluororesin flat surface 23a is facilitated as compared to the case where the surface of the first side block 17a is directly coated with the crosslinked fluororesin. Likewise, in this rotary pump, the second crosslinked fluororesin flat surface 23b is formed not on the second side block 17b to which the second bearing 14b is mounted, but on the second sliding plate 18b which is a member separate from the second side block 17b. Therefore, formation of the second crosslinked fluororesin flat surface 23b is facilitated as compared to the case where the surface of the second side block 17b is directly coated with the crosslinked fluororesin.

Furthermore, the rotary pump of the present embodiment can also be obtained by additionally incorporating the first sliding plate 18a and the second sliding plate 18b into an existing rotary pump, which realizes cost reduction.

As shown in FIG. 5, in this rotary pump, both the first mating surface 24a, of the first side member 16a, facing the ring member 15, and the second mating surface 24b, of the second side member 16b, facing the ring member 15 are formed of the crosslinked fluororesin. Therefore, the crosslinked fluororesin realizes sealing between the contact surfaces of the first side member 16a and the ring member 15, and sealing between the contact surfaces of the second side member 16b and the ring member 15. Moreover, the crosslinked fluororesin forming the first mating surface 24a is contiguous with the crosslinked fluororesin forming the first crosslinked fluororesin flat surface 23a that slides and guides the pump rotor 1, and the crosslinked fluororesin forming the second mating surface 24b is also contiguous with the crosslinked fluororesin forming the second crosslinked fluororesin flat surface 23b that slides and guides the pump rotor 1, which realizes reduction in production cost.

Moreover, in this rotary pump, the first crosslinked fluororesin flat surface 23a is formed on the first non-opening portion 29a separating the first suction port 27a and the first discharge port 28a. Therefore, a clearance between the first non-opening portion 29a and each of the first inner rotor side surface 12a and the first outer rotor side surface 13a can be made extremely small, whereby the leakage amount of fluid from the first discharge port 28a to the first suction port 27a can be effectively reduced. Likewise, the second crosslinked fluororesin flat surface 23b is formed on the second non-opening portion 29b separating the second suction port 27b and the second discharge port 28b. Therefore, a clearance between the second non-opening portion 29b and each of the second inner rotor side surface 12b and the second outer rotor side surface 13b can be made extremely small, whereby the leakage amount of fluid from the second discharge port 28b to the second suction port 27b can be effectively reduced. Thus, the discharge amount of the pump can be effectively improved.

Moreover, in this rotary pump, since the first sliding plate 18a is composed of the metal plate 25, and the crosslinked fluororesin coating 26 formed on at least the surface, of the metal plate 25, on the ring member 15 side, strength of the first sliding plate 18a can be ensured. Therefore, when the first sliding plate 18a is sandwiched between the first side block 17a and the ring member 15, breakage of the first sliding plate 18a can be avoided. Likewise, since the second sliding plate 18b is also composed of the metal plate 25, and the crosslinked fluororesin coating 26 formed on at least the surface, of the metal plate 25, on the ring member 15 side, strength of the second sliding plate 18b can be ensured. Therefore, when the second sliding plate 18b is sandwiched between the second side block 17b and the ring member 15, breakage of the second sliding plate 18b can be avoided.

In the above embodiment, as the first sliding plate 18a and the second sliding plate 18b, the metal plate 25 having the crosslinked fluororesin coating 26 formed at only one surface thereof, has been described. However, as the first sliding plate 18a and the second sliding plate 18b, the metal plate 25 having the crosslinked fluororesin coating 26 formed at both surfaces thereof (i.e., the surface facing the side block and the surface facing the ring member 15), may be adopted. This allows use of dipping or the like as a coating method, whereby the crosslinked fluororesin coating 26 having an accurate thickness can be inexpensively obtained. When the coating is performed by dipping, an inner surface of a hole 33 (see FIG. 5) into which the bolt 19 is to be inserted is also coated with the crosslinked fluororesin coating 26.

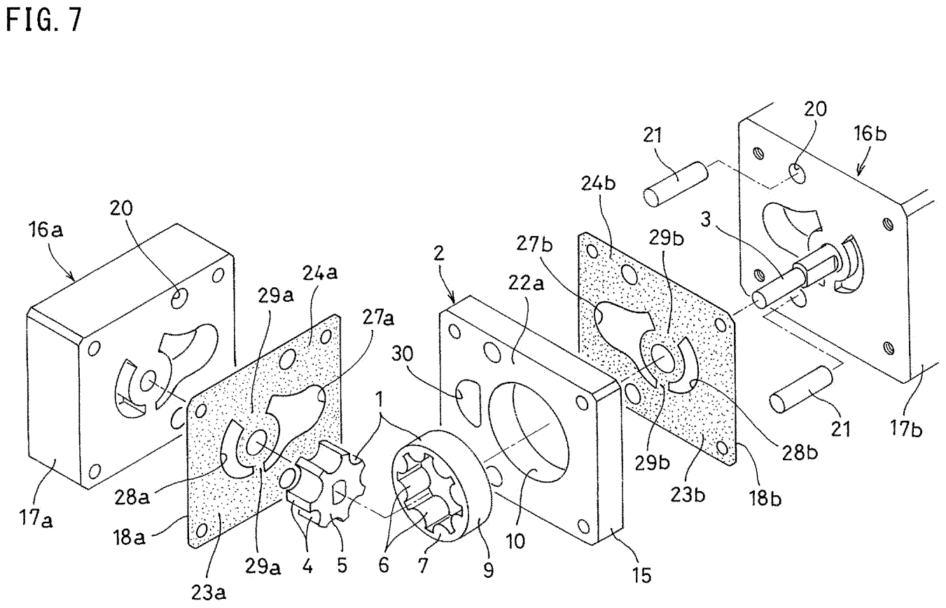

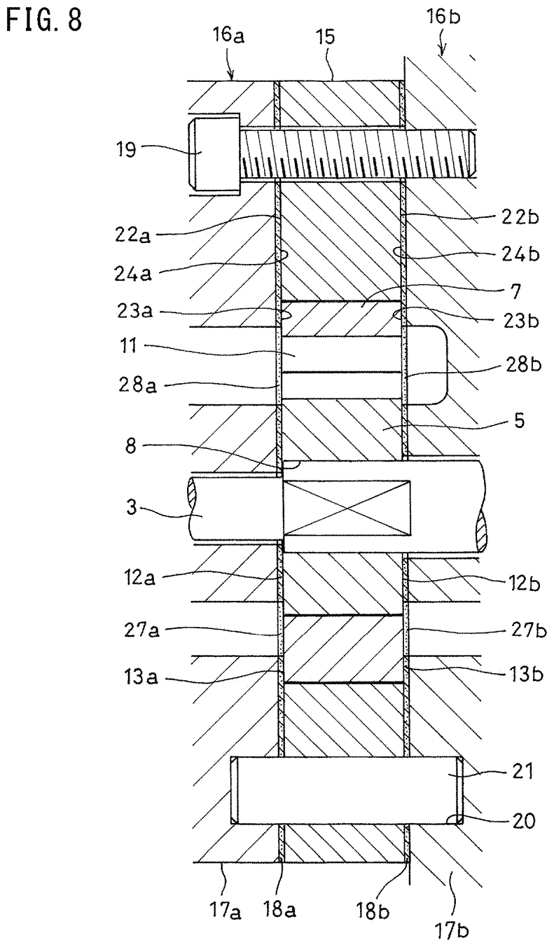

FIG. 7 and FIG. 8 show a rotary pump according to a second embodiment of the present disclosure. The second embodiment is different from the first embodiment only in the configurations of the first sliding plate 18a and the second sliding plate 18b, and the other configurations are the same as those of the first embodiment. Therefore, the parts corresponding to those of the first embodiment are denoted by the same reference signs, and description thereof is omitted.

The first sliding plate 18a is a thin plate formed of the crosslinked fluororesin. That is, the entirety of the first sliding plate 18a is formed of the crosslinked fluororesin. The first sliding plate 18a is a flat plate having a uniform thickness not larger than 1 mm (preferably, not larger than 0.5 mm). The second sliding plate 18b is formed similarly to the first sliding plate 18a.

In this rotary pump, the first crosslinked fluororesin flat surface 23a is formed not on the first side block 17a to which the first bearing 14a is mounted, but on the first sliding plate 18a which is a member separate from the first side block 17a. Therefore, formation of the first crosslinked fluororesin flat surface 23a is facilitated as compared to the case where the surface of the first side block 17a is directly coated with the crosslinked fluororesin. Likewise, in the rotary pump, the second crosslinked fluororesin flat surface 23b is formed not on the second side block 17b to which the second bearing 14b is mounted, but on the second sliding plate 18b which is a member separate from the second side block 17b. Therefore, formation of the second crosslinked fluororesin flat surface 23b is facilitated as compared to the case where the surface of the second side block 17b is directly coated with the crosslinked fluororesin.

Furthermore, the rotary pump of the present embodiment can also be obtained by additionally incorporating the first sliding plate 18a and the second sliding plate 18b into an existing rotary pump, which realizes cost reduction.

Moreover, in this rotary pump, as shown in FIG. 8, the first sliding plate 18a and the second sliding plate 18b realize sealing between the contact surfaces of the first side member 16a and the ring member 15, and sealing between the contact surfaces of the second side member 16b and the ring member 15, respectively.

Moreover, in this rotary pump, the first sliding plate 18a realizes insulation between the first side block 17a and the ring member 15, and the second sliding plate 18b realizes insulation between the second side block 17b and the ring member 15, thereby avoiding electric corrosion due to direct contact of the first side block 17a with the ring member 15, and electric corrosion due to direct contact of the second side block 17b with the ring member 15. For example, when the first side block 17a and the second side block 17b are formed of an aluminum alloy and the ring member 15 is formed of steel, it is possible to avoid electric corrosion of the first side block 17a and the second side block 17b due to a potential difference between the aluminum alloy and the steel.

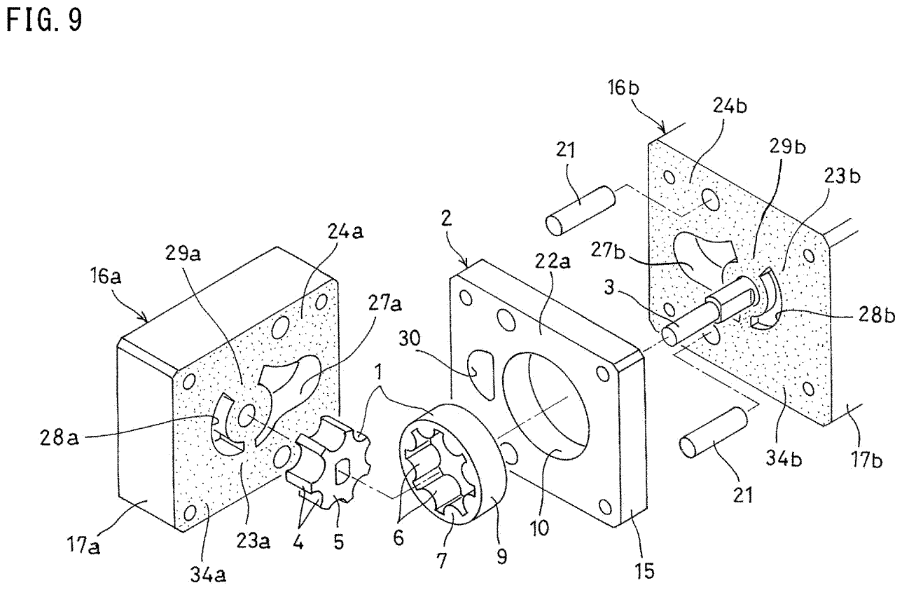

FIG. 9 shows a rotary pump according to a third embodiment of the present disclosure. In FIG. 9, the parts corresponding to those of the aforementioned embodiments are denoted by the same reference signs, and description thereof is omitted.

The first side member 16a is composed of a first side block 17a, and a first crosslinked fluororesin coating 34a formed on a surface, of the first side block 17a, on the ring member 15 side. Likewise, the second side member 16b is composed of a second side block 17b, and a second crosslinked fluororesin coating 34b formed on a surface, of the second side block 17b, on the ring member 15 side. Here, the first crosslinked fluororesin coating 34a forms the first crosslinked fluororesin flat surface 23a, and the second crosslinked fluororesin coating 34b forms the second crosslinked fluororesin flat surface 23b.

In this rotary pump, as in the aforementioned embodiments, since the first side member 16a and the second side member 16b are detachable from the ring member 15 surrounding the radially outer side of the pump rotor 1, the first crosslinked fluororesin flat surface 23a and the second crosslinked fluororesin flat surface 23b can be accurately formed in the state where the ring member 15 is absent. Therefore, clearances between the first crosslinked fluororesin flat surface 23a and the second crosslinked fluororesin flat surface 23b, and the side surfaces in the axial direction of the inner rotor 5 and the outer rotor 7 can be accurately controlled, and moreover, excellent mass productivity can be achieved.

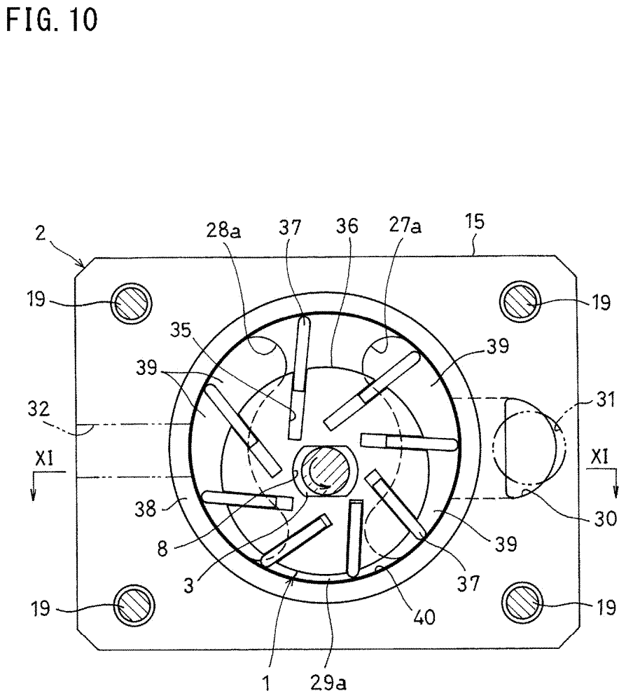

FIG. 10 to FIG. 12 show a rotary pump according to a fourth embodiment of the present disclosure. The fourth embodiment is different from the first embodiment in the configuration of the pump rotor 1, and the other configurations are the same as those of the first embodiment. Therefore, the parts corresponding to those of the first embodiment are denoted by the same reference signs, and description thereof is omitted.

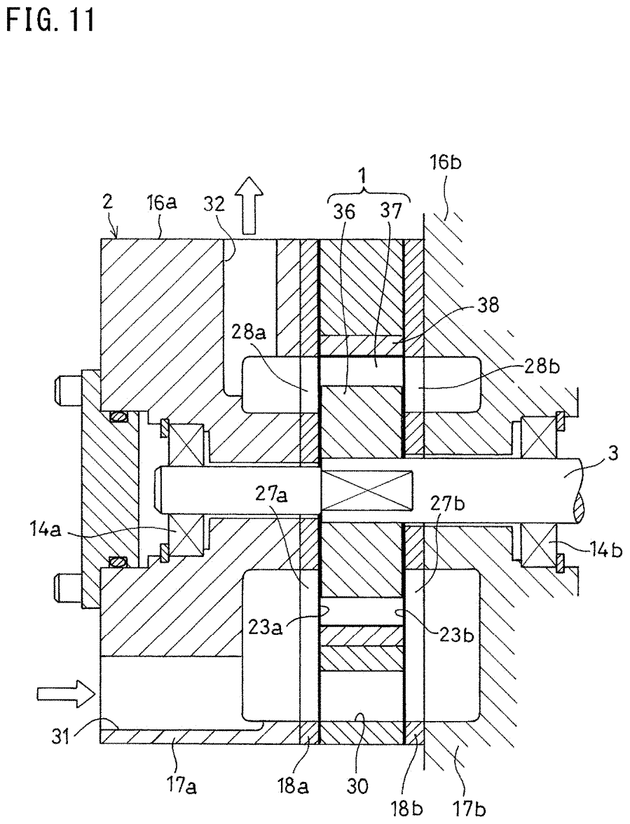

As shown in FIG. 10 and FIG. 11, the pump rotor 1 is composed of: a rotor body 36 having, at an outer periphery thereof, a plurality of vane-containing grooves 35; and a plurality of vanes 37 contained in the respective vane-containing grooves 35 so as to be slidable in the radial direction. A radially outer end of each vane 37 is slidably in contact with an inner periphery of a cam ring 38. A plurality of chambers 39 (spaces for containing fluid) demarcated by the vanes 37 are formed between the outer periphery of the rotor body 36 and the inner periphery of the cam ring 38. The inner periphery of the cam ring 38 is configured such that the volume of each chamber 39 changes with rotation of the rotor body 36, and a fluid discharge effect is caused by reduction in the volume of the chamber 39 while a fluid suction effect is caused by gradual increase in the volume of the chamber 39.

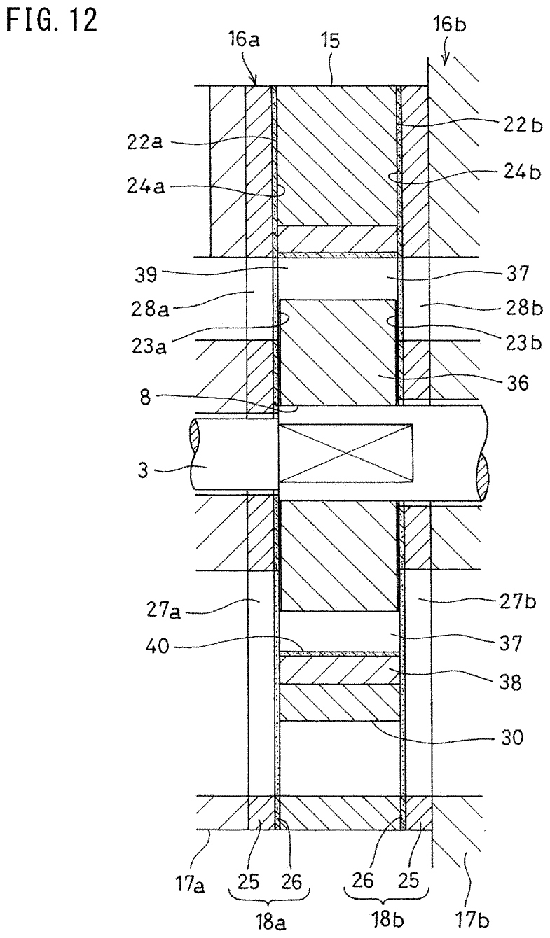

As shown in FIG. 12, the first sliding plate 18a has: a first crosslinked fluororesin flat surface 23a that slides and guides side surfaces, on one side (left side in FIG. 12) in the axial direction, of the rotor body 36 and the vanes 37; and a first mating surface 24a that is fixed while being in contact with the first flange surface 22a of the ring member 15. The second sliding plate 18b has: a second crosslinked fluororesin flat surface 23b that slides and guides side surfaces, on the other side (right side in FIG. 12) in the axial direction, of the rotor body 36 and the vanes 37; and a second mating surface 24b that is fixed while being in contact with the second flange surface 22b of the ring member 15. The inner periphery of the cam ring 38 is coated with a crosslinked fluororesin coating 40. The first crosslinked fluororesin flat surface 23a is formed on the first non-opening portion 29a (see FIG. 10) separating the first suction port 27a and the first discharge port 28a. Likewise, the second crosslinked fluororesin flat surface 23b is formed on the second non-opening portion 29b separating the second suction port 27b and the second discharge port 28b. A width in the axial direction of the rotor body 36 is equal to a width in the axial direction of each vane 37.

In this rotary pump, as shown in FIG. 12, the first crosslinked fluororesin flat surface 23a and the second crosslinked fluororesin flat surface 23b slide and guide the side surfaces of the rotor body 36 and the vanes 37. Therefore, a clearance in the axial direction between the housing 2, and the rotor body 36 and each vane 37 (i.e., a difference between the inner width of the housing 2 and the width of the rotor body 36 or the width of each vane 37) can be set to an extremely small size.

Moreover, in this rotary pump, since the first side member 16a and the second side member 16b are detachable from the ring member 15 surrounding the radially outer side of the pump rotor 1, the first crosslinked fluororesin flat surface 23a and the second crosslinked fluororesin flat surface 23b can be accurately formed in the state where the ring member 15 is absent. Therefore, clearances between the first crosslinked fluororesin flat surface 23a and the second crosslinked fluororesin flat surface 23b, and the side surfaces in the axial direction of the rotor body 36 and each vane 37 can be accurately controlled, and moreover, excellent mass productivity can be achieved.

### REFERENCE SIGNS LIST

1 pump rotor

2 housing

3 rotation shaft

3a portion protruding to one side of rotation shaft

3b portion protruding to the other side of rotation shaft

4 outer teeth

5 inner rotor

6 inner teeth

7 outer rotor

8 axial hole

9 outer peripheral cylindrical surface

10 inner peripheral cylindrical surface

11 chamber

12a first inner rotor side surface

12b second inner rotor side surface

13a first outer rotor side surface

13b second outer rotor side surface

14a first bearing

14b second bearing

15 ring member

16a first side member

16b second side member

17a first side block

17b second side block

18a first sliding plate

18b second sliding plate

19 bolt

20 knock pin insertion hole

21 knock pin

22a first flange surface

22b second flange surface

23a first crosslinked fluororesin flat surface

23b second crosslinked fluororesin flat surface

24a first mating surface

24b second mating surface

25 metal plate

26 crosslinked fluororesin coating

27a first suction port

27b second suction port

28a first discharge port

28b second discharge port

29a first non-opening portion

29b second non-opening portion

30 communication path

31 suction port

32 discharge port

33 hole

34a first crosslinked fluororesin coating

34b second crosslinked fluororesin coating

35 vane-containing groove

36 rotor body

37 vane

38 cam ring

39 chamber

40 crosslinked fluororesin coating

1. A rotary pump comprising:
a pump rotor having a flat first rotor side surface facing one side in an axial direction, and a flat second rotor side surface facing the other side in the axial direction; and
a housing configured to rotatably house the pump rotor, wherein
the housing includes
a ring member having a hollow tubular shape and openings at both ends in the axial direction, the ring member surrounding an outer side in a radial direction of the pump rotor,
a first side member detachably mounted to one end in the axial direction of the ring member, the first side member configured to slide and guide the first rotor side surface by using a first crosslinked fluororesin flat surface formed of a crosslinked fluororesin, and
a second side member detachably mounted to the other end in the axial direction of the ring member, the second side member configured to slide and guide the second rotor side surface by using a second crosslinked fluororesin flat surface formed of the crosslinked fluororesin.

2. The rotary pump according to claim 1, wherein
the ring member includes a first flange surface formed around one opening in the axial direction of the ring member, and a second flange surface formed around the other opening in the axial direction of the ring member,
the first side member has a first mating surface fixed while being in contact with the first flange surface, and the first mating surface is formed of the crosslinked fluororesin contiguous with the crosslinked fluororesin forming the first crosslinked fluororesin flat surface, and
the second side member has a second mating surface fixed while being in contact with the second flange surface, and the second mating surface is formed of the crosslinked fluororesin contiguous with the crosslinked fluororesin forming the second crosslinked fluororesin flat surface.

3. The rotary pump according to claim 1, wherein
the first side member or the second side member has: a suction port opened at a surface opposing the first rotor side surface or a surface opposing the second rotor side surface; a discharge port opened at a distance in a circumferential direction from the suction port; and a non-opening portion separating the suction port and the discharge port in the circumferential direction, and
the first crosslinked fluororesin flat surface or the second crosslinked fluororesin flat surface is formed on the non-opening portion.

4. The rotary pump according to claim 1, wherein
a rotation shaft for rotating the pump rotor is disposed so as to have a portion protruding in the axial direction from the pump rotor, and
the first side member or the second side member comprises: a side block to which a bearing is mounted, the bearing rotatably supporting the portion, of the rotation shaft, protruding in the axial direction from the pump rotor; and a sliding plate that is fixed by being sandwiched between the side block and the ring member, and has the first crosslinked fluororesin flat surface or the second crosslinked fluororesin flat surface.

5. The rotary pump according to claim 4, wherein
the sliding plate comprises a metal plate, and a crosslinked fluororesin coating formed on at least a surface, of the metal plate, on a side where the ring member is present.

6. The rotary pump according to claim 5, wherein
the crosslinked fluororesin coating is formed on both a surface, of the metal plate, on a side where the side block is present, and the surface, of the metal plate, on the side where the ring member is present.

7. The rotary pump according to claim 4, wherein
the sliding plate is a plate formed of the crosslinked fluororesin.

8. The rotary pump according to claim 1, wherein
the pump rotor comprises: an inner rotor having, at an outer periphery thereof, a plurality of outer teeth; and an annular outer rotor supported to be rotatable around a position eccentric from a center of the inner rotor, the outer rotor having, at an inner periphery thereof, a plurality of inner teeth meshing with the outer teeth.

9. The rotary pump according to claim 1, wherein
the pump rotor comprises: a rotor body having, at an outer periphery thereof, a plurality of vane-containing grooves; and a plurality of vanes contained in the respective vane-containing grooves so as to be slidable in the radial direction.
